(19) United States
(12) Patent Application Publication
(10) Pub. No.: US 2026/0080278 A1
(43) Pub. Date: Mar. 19, 2026

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventor: Hiroshi HASHIMOTO, Tokyo (JP)

(73) Assignee: NEC Corporation, Minato-ku, Tokyo (JP)

(21) Appl. No.: 19/110,537

(22) PCT Filed: Oct. 6, 2022
(86) PCT No.: PCT/JP2022/037489

§ 371 Date: Mar. 11, 2025

(51) Int. Cl. G06N 5/04

(52) U.S. Cl. CPC G06N 5/04

(57) ABSTRACT

An information processing system includes: a score acquisition unit that acquires a first score based on an output of a first inference model and a second score based on an output of a second inference model; a first integrated score calculation unit that calculates a first integrated score; a second integrated score calculation unit that calculates a second integrated score; a score determination unit that determines whether or not each of the first integrated score and the second integrated score exceeds a predetermined threshold, and that determines whether or not it is in a specific state in which only the second integrated score exceeds the predetermined threshold; and an output unit that outputs an inference result in response to not being in the specific state, and that outputs information differing from the inference result in response to being in the specific state.

### TECHNICAL FIELD

The present disclosure relates to technical fields of an information processing system, an information processing method, and a recording medium.

### BACKGROUND ART

A know system of this type calculates various scores by using a learned estimation model. For example, Patent Literature 1 discloses that in a system for performing face authentication, a reference facial image that satisfies a score threshold is selected as a facial image candidate for authentication, and the facial image candidate and a calculation score thereof are selected as authentication information. Patent Literature 2 discloses that an attribute-dependent score and a non-attribute-dependent score are integrated and outputted as a matching score.

As another related technique/technology, for example, Patent Literature 3 discloses that in response to an error occurring in face authentication, information indicating how to deal with the error is outputted to an authentication target person.

### CITATION LIST

### Patent Literature

Patent Literature 1: International Publication No. WO2020/050413
Patent Literature 2: International Publication No. WO2018/173194
Patent Literature 3: International Publication No. WO2017/043314

### SUMMARY

### Technical Problem

The present disclosure aims to improve the techniques/technologies disclosed in Citation List.

### Solution to Problem

An information processing system according to an example aspect of the present disclosure includes: a score acquisition unit that acquires a first score based on an output of a first inference model and a second score based on an output of a second inference model differing in characteristics from the first inference model; a first integrated score calculation unit that calculates a first integrated score by integrating the first score and the second score; a second integrated score calculation unit that calculates a second integrated score by integrating the first score and the second score such that a weight of the second score is larger than that in a case of calculation of the first integrated score; a score determination unit that determines whether or not each of the first integrated score and the second integrated score exceeds a predetermined threshold, and that determines whether or not it is in a specific state in which only the second integrated score exceeds the predetermined threshold; and an output unit that outputs an inference result based on whether or not the first integrated score exceeds the predetermined threshold in response to not being in the specific state, and that outputs information differing from the inference result in response to being in the specific state.

An information processing method according to an example aspect of the present disclosure includes: acquiring a first score based on an output of a first inference model and a second score based on an output of a second inference model differing in characteristics from the first inference model; calculating a first integrated score by integrating the first score and the second score; calculating a second integrated score by integrating the first score and the second score such that a weight of the second score is larger than that in a case of calculation of the first integrated score; determining whether or not each of the first integrated score and the second integrated score exceeds a predetermined threshold, and determining whether or not it is in a specific state in which only the second integrated score exceeds the predetermined threshold; and outputting an inference result based on whether or not the first integrated score exceeds the predetermined threshold in response to not being in the specific state, and outputting information differing from the inference result in response to being in the specific state.

A recording medium according to an example aspect of the present disclosure is a recording medium on which a computer program that allows at least one computer to execute an information processing method is recorded, the information processing method including: acquiring a first score based on an output of a first inference model and a second score based on an output of a second inference model differing in characteristics from the first inference model; calculating a first integrated score by integrating the first score and the second score; calculating a second integrated score by integrating the first score and the second score such that a weight of the second score is larger than that in a case of calculation of the first integrated score; determining whether or not each of the first integrated score and the second integrated score exceeds a predetermined threshold, and determining whether or not it is in a specific state in which only the second integrated score exceeds the predetermined threshold; and outputting an inference result based on whether or not the first integrated score exceeds the predetermined threshold in response to not being in the specific state, and outputting information differing from the inference result in response to being in the specific state.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of operation of the information processing system according to the first example embodiment.

FIG. 4 is a flowchart illustrating a flow of operation of an information processing system according to a second example embodiment.

FIG. 5 is a graph illustrating an area corresponding to a specific state in the information processing system according to the second example embodiment.

FIG. 6 is a graph illustrating a method of determining the area corresponding to the specific state in an information processing system according to a third example embodiment.

FIG. 7 is a graph illustrating a method of calculating a size of the area corresponding to the specific state in the information processing system according to the third example embodiment.

FIG. 8 is a block diagram illustrating a functional configuration of an information processing system according to a fourth example embodiment.

FIG. 9 is a flowchart illustrating a flow of operation of the information processing system according to the fourth example embodiment.

FIG. 10 is a graph illustrating the area corresponding to the specific state in the information processing system according to the fourth example embodiment.

FIG. 11 is a block diagram illustrating a configuration of a model used by an information processing system 10 according to a fifth example embodiment.

FIG. 12 is a graph illustrating the area corresponding to the specific state in the information processing system according to the fifth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

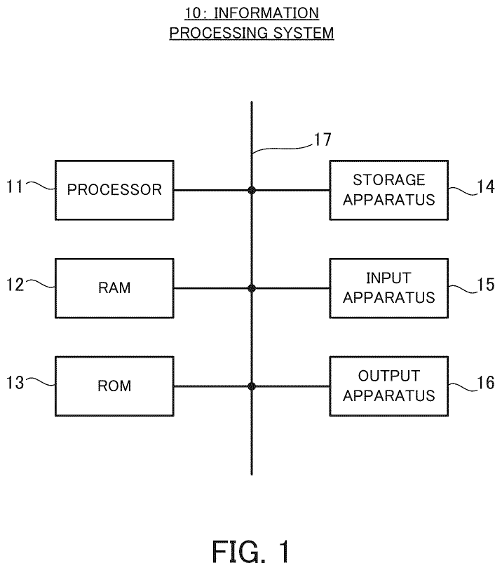

An information processing system according to a first example embodiment will be described with reference to FIG. 1 to FIG. 3.

### (Hardware Configuration)

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, an information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The processor 11, the RAM 12, the ROM 13, the storage apparatus 14, the input apparatus 15, and the output apparatus 16 are connected via a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10 via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for integrating scores of inference models and outputting an inference result based on the integrated scores is realized or implemented in the processor 11. That is, the processor 11 may function as a controller for executing each control in the information processing system 10.

The processor 11 may be configured as, for example, a CPU (Central Processing Unit), a GPU (Graphics Processing Unit), a FPGA (field-programmable gate array), a DSP (Demand-Side Platform), an ASIC (Application Specific Integrated Circuit), or a quantum processor. The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used in place of the RAM 12.

The ROM 13 stores the computer program to be executed by the processor 11. The ROM 13 may also store fixed data. The ROM 13 may be, for example, a P-ROM (Programmable Read Only Memory) or an EPROM (Erasable Read Only Memory). Furthermore, another type of non-volatile memory may also be used in place of the ROM13.

The storage apparatus 14 stores data that are stored by the information processing system 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information-processing system 10. The output apparatus 16 may be a speaker or the like that is configured to audio-output the information about the information processing system 10. The output apparatus 16 may be configured as a portable terminal such as a smartphone and a tablet. The output apparatus 16 may be an apparatus that outputs information in a format other than an image. For example, the output apparatus 16 may be a speaker that audio-outputs the information about the information processing system 10.

Although FIG. 1 illustrates the information processing system 10 including a plurality of apparatuses, all or a part of the functions may be realized or implemented in a single apparatus (an information processing apparatus). In such a case, the information processing apparatus may include, for example, only the processor 11, the RAM 12, and the ROM 13. The other components (i.e., the storage apparatus 14, the input apparatus 15, and the output apparatus 16) may be provided in an external apparatus connected to the information processing apparatus. In addition, in the information processing apparatus, a part of an arithmetic function may be realized by an external apparatus (e.g., an external server or cloud, etc.).

### (Functional Configuration)

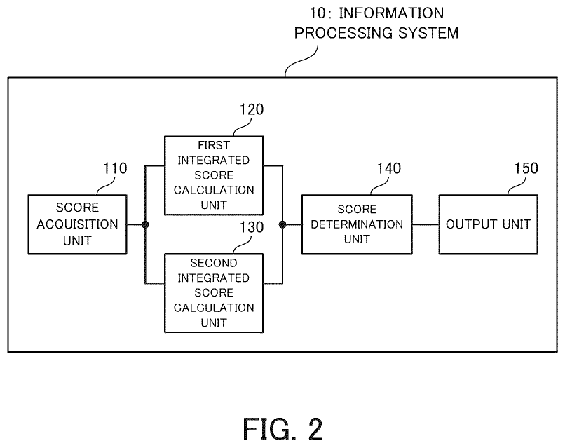

Next, with reference to FIG. 2, a functional configuration of the information processing system 10 according to the first example embodiment will be described. FIG. 2 is a block diagram illustrating the functional configuration of the information processing system according to the first example embodiment.

The information processing system 10 according to the first example embodiment is configured to integrate outputs (scores) of a plurality of inference models having different characteristics from each other and to output an inference result. In the following, the inference models are referred to as a first inference model and a second inference model. Specific aspects of the first inference model and the second inference model are not particularly limited, but these models may be configured as authentication models used in performing biometric authentication, or detection models used in detecting illness/disease such as cancer, for example. The information processing system 10 may be configured such that the system itself includes the inference model, or may be configured such that an inference model outside the system is utilized.

As illustrated in FIG. 2, the information processing system 10 according to the first example embodiment includes, as components for realizing the functions thereof, a score acquisition unit 110, a first integrated score calculation unit 120, a second integrated score calculation unit 130, a score determination unit 140, and an output unit 150. Each of the score acquisition unit 110, the first integrated score calculation unit 120, the second integrated score calculation unit 130, the score determination unit 140, and the output unit 150 may be a processing block realized or implemented by the processor 11 (see FIG. 1), for example.

The score acquisition unit 110 is configured to acquire a first score based on an output of the first inference model and a second score based on an output of the second inference model (i.e., a model differing in characters from the first inference model). Each of the first score and the second score acquired by the score acquisition unit 110 is configured to be outputted to the first integrated score calculation unit 120 and the second integrated score calculation unit.

The first integrated score calculation unit 120 is configured to calculate a first integrated score by integrating the first score and the second score. Although there is no particular limitation on a method of calculating the first integrated score, the first integrated score calculation unit 120 performs integrated processing by weighting the first score and the second score. The first integrated score calculated by the first integrated score calculation unit 120 is configured to be outputted to the score determination unit 140.

The second integrated score calculation unit 130 is configured to calculate a second integrated score by integrating the first score and the second score. Although there is no particular limitation on a method of calculating the second integrated score, the second integrated score calculation unit 130 is configured to perform the integrated processing such that a weight of the second score is larger than that in a case of calculation of the first integrated score (i.e., the processing of the first integrated score calculation unit 120). Therefore, the first integrated score and the second integrated score are different from each other. The second integrated score calculated by the second integrated score calculation unit 130 is configured to be outputted to the score determination unit 140.

The score determination unit 140 is configured to perform various types of determination processing by using the first integrated score calculated by the first integrated score calculation unit 120 and the second integrated score calculated by the second integrated score calculation unit 130. Specifically, the score determination unit 140 is configured to determine whether or not each of the first integrated score and the second integrated score exceeds a predetermined threshold. The “predetermined threshold” here is a value set in advance to obtain an inference result. The score determination unit 140 is configured to determine whether or not it is in a specific state. The “specific state” here refers to a state in which, among the first integrated score and the second integrated score, only the second integrated score exceeds the predetermined threshold. A result of determination by the score determination unit 140 is configured to be outputted to the output unit 150.

The output unit 150 is configured to output various types of information depending on the determination result of the score determination unit 140. Specifically, when it is determined in the score determination unit 140 that it is not in the specific state, the output unit 140 outputs the inference result based on whether or not the first integrated score exceeds the predetermined threshold. On the other hand, when it is determined in the score determination unit 140 that it is in the specific state, the output unit 140 outputs information that is different from the inference result. A specific example of the information that is different from the inference result will be described in detail in another example embodiment described later.

### (Flow of Operation)

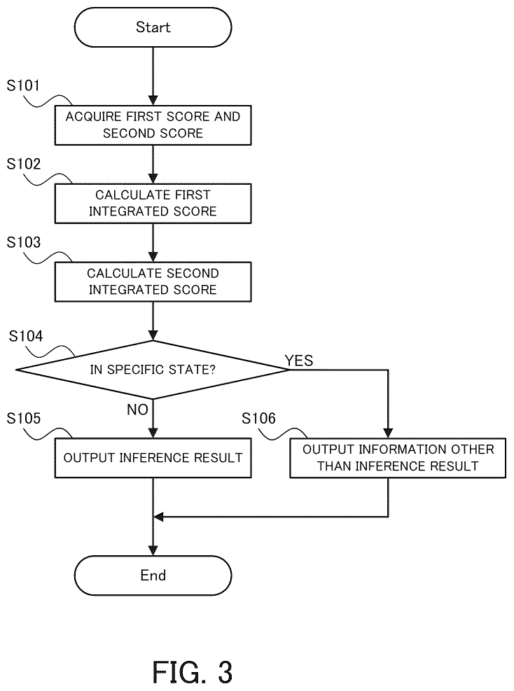

Next, with reference to FIG. 3, a flow of operation by the information processing system 10 according to the first example embodiment will be described. FIG. 3 is a flowchart illustrating the flow of the operation of the information processing system according to the first example embodiment.

As illustrated in FIG. 3, when the operation of the information processing system 10 according to the first example embodiment is started, first, the score acquisition unit 120 acquires the first score based on the output of the first inference model and the second score based on the output of the second inference model (step S101). The score acquisition unit 120 may acquire the first score and the second score, simultaneously or sequentially.

Subsequently, the first integrated score calculation unit 120 calculates the first integrated score, based on the first score and the second score acquired by the score acquisition unit 120 (step S102). Furthermore, the second integrated score calculation unit 130 calculates the second integrated score, based on the first score and the second score acquired by the score acquisition unit 120 (step S103). The step S102 and the step S103 may be performed separately, wherein either one of the steps may be performed first, or may be performed simultaneously in parallel.

Subsequently, the score determination unit 140 determines whether or not it is in the specific state, based on the first integrated score calculated by the first integrated score calculation unit 120 and the second integrated score calculated by the second integrated score calculation unit 130 (step S104). When it is determined that it is not in the specific state (the step 104: NO), the score determination unit 140 performs inference based on the first integrated score, and the output unit 150 outputs the inference result (step S105). On the other hand, when it is determined that it is in the specific state (the step 104: YES), the output unit 150 outputs information other than the inference result.

### (Technical Effect)

Next, a technical effect obtained by the information processing system 10 according to the first example embodiment will be described.

As described in FIG. 1 to FIG. 3, in the information processing system 10 according to the first example embodiment, the first integrated score and the second integrated score are calculated from the first score by the first inference model and the second score by the second inference model. Then, the inference result or the information other than the inference result are outputted depending on the determination result using the first integrated score and the second integrated score. In this way, it is possible to output more appropriate information in consideration of the characteristics of each of the plurality of models. The output in consideration of the characteristics of the inference model will be described in detail in another example embodiment described later.

### Second Example Embodiment

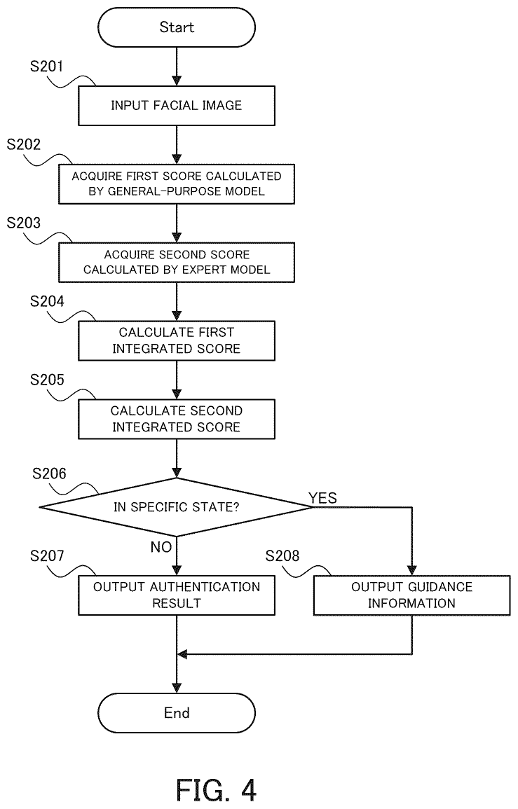

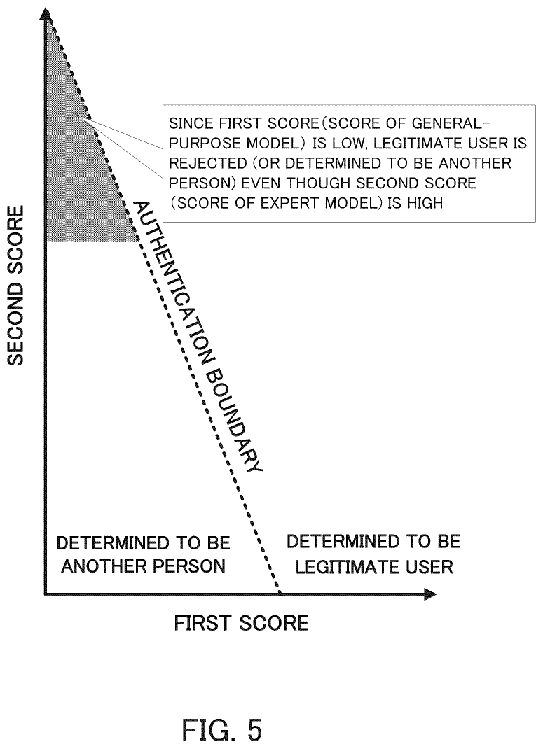

The information processing system 10 according to a second example embodiment will be described with reference to FIG. 4 and FIG. 5. The second example embodiment partially differs from the first example embodiment only in the configuration and operation, and may be the same as the first example embodiment in the other parts. For this reason, a part differing from the first example embodiment will be described in detail below, and a description of the other overlapping parts will be omitted as appropriate.

### (Authentication Model)

First, the inference model used in the information processing system 10 according to the second example embodiment will be described.

In the information processing system 10 according to the second example embodiment, the first inference model and the second inference model are configured as authentication models. The authentication model is a model that uses information about a target person as an input and that determines whether or not the target person is a registered user. The authentication model may be configured as a biometric authentication model in which authentication processing is performed by using an image of a living body (or a feature quantity extracted from the image of the living body), for example. For example, the authentication model may be configured as a face authentication model in which authentication is performed by using a facial image, or as an iris authentication model in which authentication is performed by using an iris image. In this case, the first inference model and the second inference model may be configured as models that uses respective pieces of information about respective modals as inputs. For example, the first inference model may be configured as the face authentication model and the second inference model may be configured as the iris authentication model. In this instance, the information processing system 10 may be configured as an authentication system that is configured to perform multi-modal authentication.

The following describes an example in which the first inference model and the second inference model are configured as the face authentication models. In addition, it is assumed that the first inference model is configured as a model widely adapted to a face in general (hereinafter referred to as a “general-purpose model” as appropriate) and that the second inference model is configured as a model specializing in a part of a face (hereinafter referred to as an “expert model” as appropriate). An example of the expert model may be a model specializing in a face wearing a mask, a model specializing in a face in profile, or the like.

### (Flow of Operation)

Next, with reference to FIG. 4, a flow of operation by the information processing system 10 according to the second example embodiment will be described. FIG. 4 is a flowchart illustrating the flow of the operation of the information processing system according to the second example embodiment.

As illustrated in FIG. 4, when the operation of the information processing system 10 according to the second example embodiment is started, first, the facial image of an authentication target is inputted into the authentication models (i.e., the general-purpose model and the expert model) (step S201). Incidentally, a feature quantity extracted from the facial image may be inputted to the authentication models.

Subsequently, the score acquisition unit 120 acquires the first score calculated by the general-purpose model (step S202). In addition, the score acquisition unit 120 acquires the second score calculated by the expert model (step S203).

Subsequently, the first integrated score calculation unit 120 calculates the first integrated score, based on the first score and the second score acquired by the score acquisition unit 120 (step S204). The second integrated score calculation unit 130 calculates the second integrated score, based on the first score and the second score acquired by the score acquisition unit 120 (step S205). As already described, the second integrated score is calculated such that the weight of the second score (i.e., the score calculated by the expert model) is larger than that in the case of the first integrated score.

Subsequently, the score determination unit 140 determines whether or not it is in the specific state, based on the first integrated score calculated by the first integrated score calculation unit 120 and the second integrated score calculated by the second integrated score calculation unit 130 (step S206). When it is determined that it is not in the specific state (the step 206: NO), the score determination unit 140 performs the authentication processing based on the first integrated score, and the output unit 150 outputs an authentication result (step S207). For example, in a case where the first integrated score exceeds the predetermined threshold, the output unit 150 outputs information indicating that the authentication is OK (i.e., the target person is a registered user). In addition, in a case where the first integrated score does not exceed the predetermined threshold, the output unit 150 outputs information indicating that the authentication is NG (i.e., the target person is not a registered user).

On the other hand, when it is determined that it is in the specific state (the step 206: YES), the output unit 150 outputs guidance information for the target person, as information other than the authentication result. The guidance information is, for example, information requesting a predetermined operation from the target person. The guidance information may be information that encourages the target person to move such that a face of the target person is at a position suitable for image capture. Specifically, a message such as “Please bring your face closer” may be outputted. Alternatively, the guidance information may be information that encourages the target person to remove a mask. Specifically, a message such as “Please remove the mask” may be outputted. These pieces of guidance information may be displayed on a display, or may be audio-outputted, for example.

### (Specific State)

Next, with reference to FIG. 5, the specific state in the information processing system 10 according to the second example embodiment will be specifically described. FIG. 5 is a graph illustrating an area corresponding to the specific state in the information processing system according to the second example embodiment.

In FIG. 5, the specific state determined by the information processing system 10 according to the second example embodiment is defined as a hatched area. Specifically, the specific state corresponds to a state in which, since the first score (i.e., the score of the general-purpose model) is low, a legitimate user is rejected (or determined to be another person) even though the second score (i.e., the score of the expert model) is high.

The specific state as described above may occur in a state in which a target is wearing a mask, for example. In a case where the target is wearing a mask, even if the target person is a legitimate user (i.e., a registered user), the first score is calculated low as the face is hidden by the mask. On the other hand, in a case where the expert model is configured as a mask specializing model, the second score is calculated high because the target can be accurately recognized even when the target is wearing a mask. In such a state, normally, the target should be determined to be a legitimate user, but when the determination is performed only by the first score, the first integrated score also becomes low due to the low first score, and there is thus a possibility that the target is determined to be another person.

In the present example embodiment, however, it is determined whether or not it is in a state in which the above-described inappropriate determination may be performed (i.e., the specific state), by using the second integrated score calculated with an increased weight of an expert score or the second score. When it is in the specific state, the authentication result is not outputted, and the information other than the authentication result is outputted. In the present example embodiment, the guidance information is used as an example of the information other than the authentication result, but information other than the guidance information may be outputted. For example, when it is in the specific state, alert information (i.e., information for calling attention to a possibility that accurate authentication may not be performed) may be outputted.

### (Technical Effect)

Next, a technical effect obtained by the information processing system 10 according to the second example embodiment will be described.

As illustrated in FIG. 4 and FIG. 5, in the information processing system 10 according to the second example embodiment, the authentication result is outputted when it is not in the specific state, and the information other than the authentication result is outputted when it is in the specific state. In this way, it is possible to prevent an incorrect authentication result from being outputted when it is in the specific state. In addition, by outputting the guidance information when it is in the specific state, it is possible to request a predetermined operation from the target person, thereby eliminating the specific state.

### Third Example Embodiment

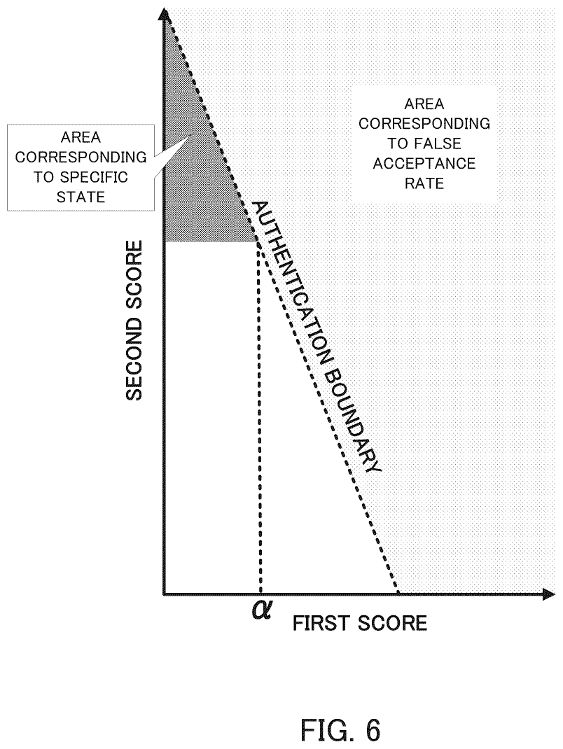

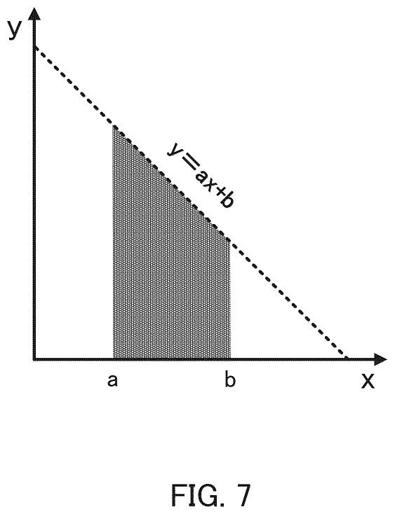

The information processing system 10 according to a third example embodiment will be described with reference to FIG. 6 and FIG. 7. The third example embodiment illustrates an example of a method of determining the area corresponding to the specific state described in the second example embodiment (see FIG. 5), and may be the same as the first and second example embodiments in the other parts. For this reason, a part differing from each of the example embodiments described above will be described in detail below, and a description of the other overlapping parts will be omitted as appropriate.

### (Method of Determining Area)

First, with reference to FIG. 6, a method of determining the area corresponding to the specific state in the information processing system 10 according to the third example embodiment will be described. FIG. 6 is a graph illustrating the method of determining an area corresponding to a specific state in the information processing system according to the third example embodiment.

As illustrated in FIG. 6, a size of the area corresponding to the specific state may be determined by determining a (i.e., a value corresponding to a width of the area). At this time, the value of a may be set based on a false acceptance rate (i.e., a possibility that another person is determined to be a legitimate user) in the authentication processing. For example, a may be determined such that a probability of occurrence of the area corresponding to the specific state in the drawing is the same as a probability of occurrence of an area corresponding to the false acceptance rate.

When the false acceptance rate is denoted by P_{FA}^{(α)}, a first integrated score τ1 may be calculated as in the following Equation (1), and a second integrated score τ2 may be calculated as in the following Equation (2).

$$\begin{matrix}[ Equation 1 ] & \\ {τ}_{1} = ( 1 - {p}^{( 0 )} ) \times ( - log {P}_{FA}^{( 0 )} ) + ( 1 - {p}^{( 1 )} ) \times ( - log {P}_{FA}^{( 1 )} ) & ( 1 )\end{matrix}$$

$$\begin{matrix}[ Equation 2 ] & \\ {τ}_{2} = ( 1 - {p}^{( 0 )} ) \times max ( - log {P}_{FA}^{( 0 )} , α ) + ( 1 - {p}^{( 1 )} ) \times ( - log {P}_{FA}^{( 1 )} ) & ( 2 )\end{matrix}$$

As described above, the second integrated score τ2 may be calculated based on the false acceptance rate. Incidentally, 1−p^{(α)} corresponds to a weight based on inference accuracy, and −log P_{FA}^{(α)} corresponds to the first score and the second score.

### (Calculation of Size of Area)

Next, with reference to FIG. 7, a method of calculating the size of the area corresponding to the specific state in the information processing system 10 according to the third example embodiment will be described. FIG. 7 is a graph illustrating the method of calculating the size of the area corresponding to the specific state in the information processing system according to the third example embodiment.

In FIG. 7, the probability of occurrence of the area corresponding to the specific state is obtained by calculating a probability of occurrence of a trapezoidal area in the drawing. Specifically, a probability P of occurrence of the area corresponding to the specific state may be calculated as in the following Equation (3).

$$\begin{matrix}[ Equation 3 ] & \\ P = {\int }_{a}^{b} ( 1 - {e}^{- c ( ax + b )} ) {e}^{- cx} dx & ( 3 )\end{matrix}$$

Here, c=ln 10. It is also assumed here that each axis indicates a negative logarithm of the false acceptance rate. Furthermore, the scores are regarded as independent (uncorrelated) from each other (i.e., a premise is that the models have different characteristics from each other).

### (Technical Effect)

Next, a technical effect obtained by the information processing system 10 according to the third example embodiment will be described.

As described in FIG. 6 and FIG. 7, in the information processing system 10 according to the third example embodiment, the size of the area corresponding to the specific state is set based on the false acceptance rate. In this way, the probability of occurrence of the specific state can be set to have an appropriate value. Therefore, it is possible to prevent that frequent occurrence of the specific state causes an increased opportunity where the information other than the authentication result is outputted, for example.

### Fourth Example Embodiment

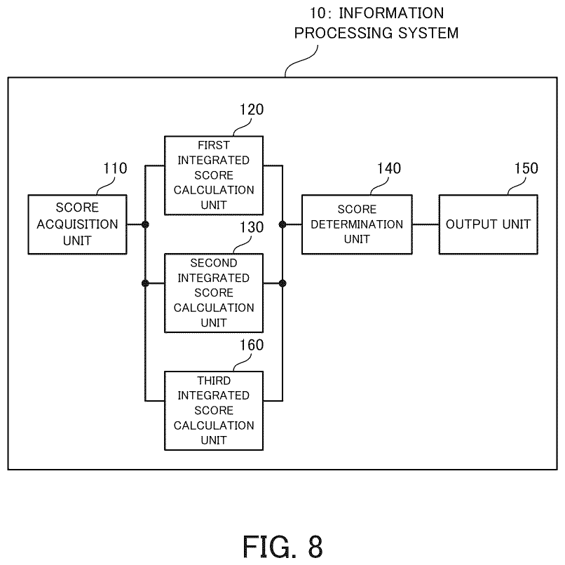

The information processing system 10 according to a fourth example embodiment will be described with reference to FIG. 8 to FIG. 10. The fourth example embodiment partially differs from the first to third example embodiments only in the configuration and operation, and may be the same as the first to third example embodiments in the other parts. For this reason, a part differing from each of the example embodiments described above will be described in detail below, and a description of the other overlapping parts will be omitted as appropriate.

### (Functional Configuration)

First, with reference to FIG. 8, a functional configuration of the information processing system 10 according to the fourth example embodiment will be described. FIG. 8 is a block diagram illustrating the functional configuration of the information processing system according to the fourth example embodiment. In FIG. 8, the same components as those described in FIG. 2 carry the same reference numerals.

As illustrated in FIG. 8, the information processing system 10 according to the fourth example embodiment includes, as components for realizing the functions thereof, the score acquisition unit 110, the first integrated score calculation unit 120, the second integrated score calculation unit 130, the score determination unit 140, the output unit 150, and a third integrated score calculation unit 160. That is, the information processing system 10 according to the fourth example embodiment includes the third integrated score calculation unit 160, in addition to the configuration in the first example embodiment (see FIG. 2). The third integrated score calculation unit 160 may be a processing block realized or implemented by the processor 11 (see FIG. 1), for example.

The third integrated score calculation unit 160 is configured to calculate a third integrated score by integrating the first score and the second score. Although there is no particular limitation on a method of calculating the third integrated score, the third integrated score calculation unit 160 is configured to perform the integrated processing such that a weight of the first score is larger than that in the case of calculation of the first integrated score (i.e., the processing of the first integrated score calculation unit 120). Therefore, the third integrated score is different from the first integrated score and the second integrated score. The third integrated score calculated by the third integrated score calculation unit 160 is configured to be outputted to the score determination unit 140.

Then, the score determination unit 140 according to the fourth example embodiment is configured to perform determination using the third integrated score, in addition to the first integrated score and the second integrated score. A determination operation of the score determination unit 140 will be described in detail later.

### (Flow of Operation)

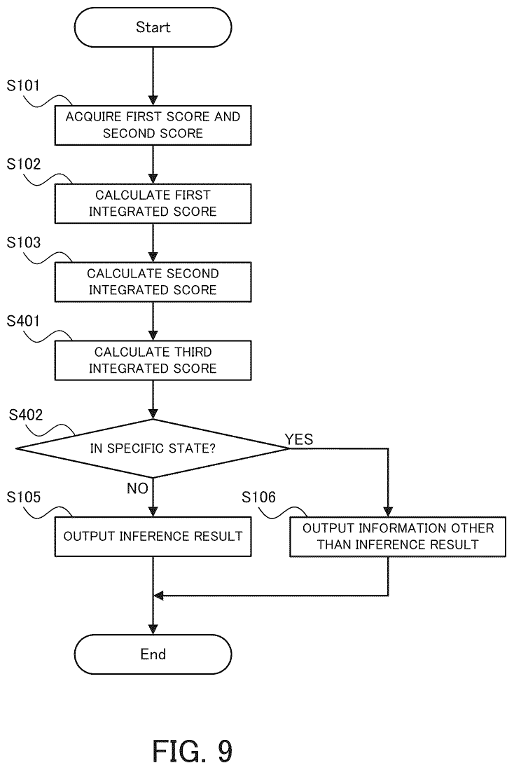

Next, with reference to FIG. 9, a flow of operation by the information processing system 10 according to the fourth example embodiment will be described. FIG. 9 is a flowchart illustrating the flow of the operation of the information processing system according to the fourth example embodiment. In FIG. 9, the same steps as those illustrated in FIG. 3 carry the same reference numerals.

As illustrated in FIG. 9, when the operation of the information processing system 10 according to the fourth example embodiment is started, first, the score acquisition unit 120 acquires the first score based on the output of the first inference model and the second score based on the output of the second inference model (step S101).

Subsequently, the first integrated score calculation unit 120 calculates the first integrated score, based on the first score and the second score acquired by the score acquisition unit 120 (step S102). Furthermore, the second integrated score calculation unit 130 calculates the second integrated score, based on the first score and the second score acquired by the score acquisition unit 120 (step S103). In addition, the third integrated score calculation unit 160 calculates the third integrated score, based on the first score and the second score acquired by the score acquisition unit 120 (step S401).

The third integrated score may be calculated in the same method as that when the second integrated score is calculated. Specifically, the first score and the second score in the above-described Equation (2) may be substituted to calculate the third integrated score.

Subsequently, the score determination unit 140 determines whether or not it is in the specific state, based on the first integrated score calculated by the first integrated score calculation unit 120, the second integrated score calculated by the second integrated score calculation unit 130, and the third integrated score calculated by the third integrated score calculation unit 160 (step S402). Here, in particular, the score determination unit 140 according to the present example embodiment determines that it is in the specific state in a case where only the second integrated score exceeds the predetermined threshold, or only the third integrated score exceeds the predetermined threshold.

When it is determined that it is not in the specific state (the step 402: NO), the score determination unit 140 performs inference based on the first integrated score, and the output unit 150 outputs the inference result (step S105). On the other hand, when it is determined that it is in the specific state (the step 402: YES), the output unit 150 outputs information other than the inference result.

### (A Plurality of Specific States)

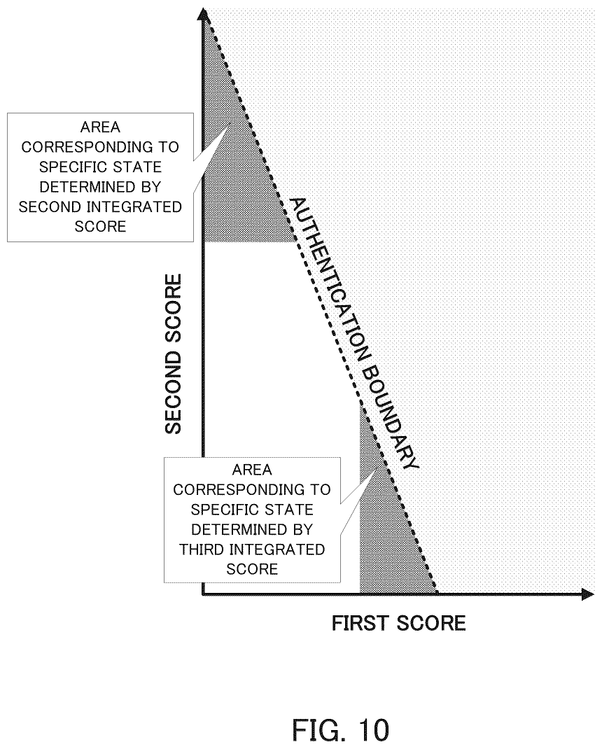

Next, with reference to FIG. 10, the specific state in the information processing system 10 according to the fourth example embodiment will be specifically described. FIG. 10 is a graph illustrating the area corresponding to the specific state in the information processing system according to the fourth example embodiment.

As illustrated in FIG. 10, in the information processing system 10 according to the fourth example embodiment, a plurality of specific states are determined. Specifically, each of the above example embodiments describes an example of determining the specific state in which the first score is low and the second score is high. In the present example embodiment, however, such a specific state that the first score is high and the second score is low, may be also determined.

### (Technical Effect)

Next, a technical effect obtained by the information processing system 10 according to the fourth example embodiment will be described.

As described in FIG. 8 to FIG. 10, in the information processing system 10 according to the fourth example embodiment, the specific state is determined by using the third integrated score. In this way, it is possible to determine a plurality of specific states, and it is therefore possible to output information in further consideration of the characteristics of each of the plurality of models, as compared with a case of determining only one specific state.

### Fifth Example Embodiment

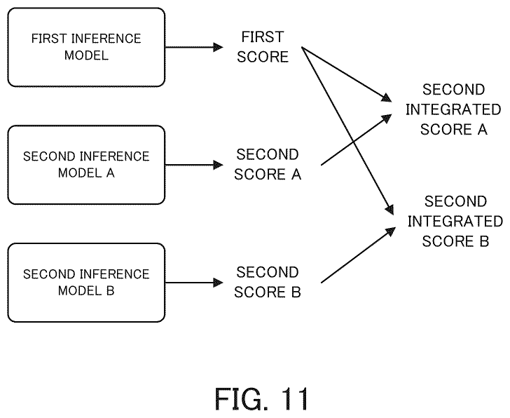

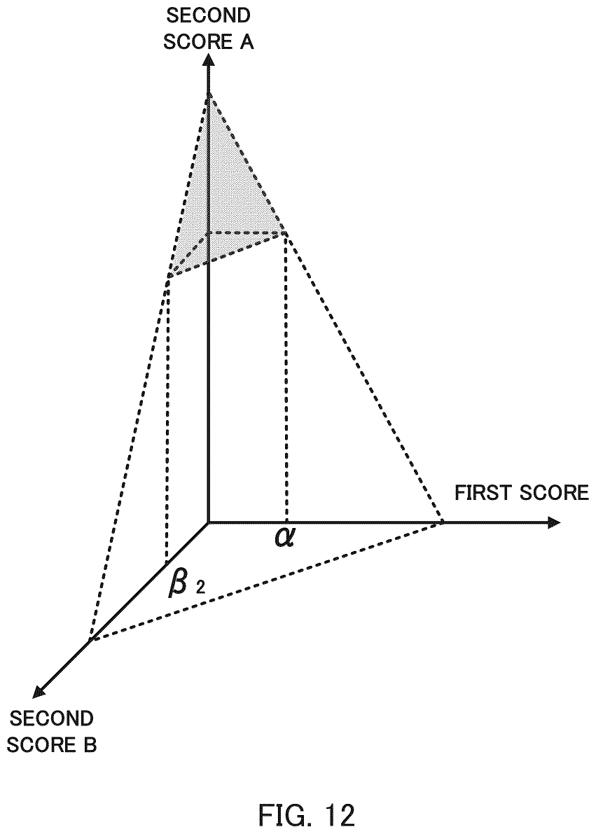

The information processing system 10 according to a fifth example embodiment will be described with reference to FIG. 11 and FIG. 12. The fifth example embodiment partially differs from the first to fourth example embodiments only in the operation, and may be the same as those of the first to fourth example embodiments in the other parts. For this reason, a part differing from each of the example embodiments described above will be described in detail below, and a description of the other overlapping parts will be omitted as appropriate.

### (Model Configuration)

First, with reference to FIG. 11, a configuration of a model used by the information processing system 10 according to the fifth example embodiment will be described. FIG. 11 is a block diagram illustrating the configuration of the model used by the information processing system 10 according to the fifth example embodiment.

As illustrated in FIG. 11, in the information processing system 10 according to the fifth example embodiment, one first inference model and two second inference models A and B are used. The first inference model outputs the first score. The second inference model A outputs a second score A. The second inference model B outputs a second score B. Therefore, the score acquisition unit 110 in the information processing system 10 according to the fifth example embodiment acquires three scores: the first score, the second score A, and the second score B.

In addition, the second integrated score calculation unit 130 according to the fifth example embodiment calculates the second integrated score for each second inference model. In other words, the second integrated score calculation unit 130 calculates the second integrated score for each second score. Specifically, the second integrated score calculation unit 130 calculates a second integrated score A from the first score and the second score A. The second integrated score calculation unit 130 calculates a second integrated score B from the first score and the second score B.

### (Specific State)

Next, with reference to FIG. 12, the specific state in the information processing system 10 according to the fifth example embodiment will be specifically described. FIG. 12 is a graph illustrating the area corresponding to the specific state in the information processing system according to the fifth example embodiment.

As illustrated in FIG. 12, in the information processing system 10 according to the fifth example embodiment, it is determined that it is in the specific state when one of the first integrated score A and the second integrated score B exceeds the predetermined threshold. The size of the area corresponding to this specific state is defined by a and 02 in the drawing. The values of a and 32 may be calculated by using the Equation (3) described in the third example embodiment (see FIG. 7). At this time, the values of a and 02 may be calculated such that the probability of occurrence of the specific area is the same as the probability of occurrence of the area corresponding to the false acceptance rate.

Although the case where there are two second inference models is described here, there may be three or more second inference models. Even in that case, it is possible to make a determination regarding the specific state in the same method by calculating the second integrated score corresponding to each of the plurality of second inference models (i.e., by calculating the second integrated score for each second score). An i-th second integration score may be calculated by using the following Equation (4), for example.

$$\begin{matrix}[ Equation 4 ] & \\ {τ}_{2}^{( i )} = ( 1 - {p}^{( 0 )} ) \times max ( - log {P}_{FA}^{( 0 )} , α ) + ( 1 - {p}^{( i )} ) \times ( - log {P}_{FA}^{( i )} ) + {\sum }_{j \neq i} ( 1 - {p}^{( j )} ) \times max ( - log {P}_{FA}^{( j )} , {β}_{j} ) & ( 4 )\end{matrix}$$

### (Technical Effect)

Next, a technical effect obtained by the information processing system 10 according to the fifth example embodiment will be described.

As described in FIG. 11 and FIG. 12, in the information processing system 10 according to the fifth example embodiment, the plurality of second integrated scores are calculated by using the plurality of second scores. In this way, even when there are a plurality of second inference models, it is possible to output more appropriate information in consideration of each characteristic of each model.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of SaaS (Software as a Service), for example.

### <Supplementary Notes>

The example embodiments described above may be further described as, but not limited to, the following Supplementary Notes below.

### (Supplementary Note 1)

An information processing system according to Supplementary Note 1 is an information processing system including: a score acquisition unit that acquires a first score based on an output of a first inference model and a second score based on an output of a second inference model differing in characteristics from the first inference model; a first integrated score calculation unit that calculates a first integrated score by integrating the first score and the second score; a second integrated score calculation unit that calculates a second integrated score by integrating the first score and the second score such that a weight of the second score is larger than that in a case of calculation of the first integrated score; a score determination unit that determines whether or not each of the first integrated score and the second integrated score exceeds a predetermined threshold, and that determines whether or not it is in a specific state in which only the second integrated score exceeds the predetermined threshold; and an output unit that outputs an inference result based on whether or not the first integrated score exceeds the predetermined threshold in response to not being in the specific state, and that outputs information differing from the inference result in response to being in the specific state.

### (Supplementary Note 2)

An information processing system according to Supplementary Note 2 is the information processing system according to Supplementary Note 1, wherein the first inference model and the second inference model are authentication models that use information about a target person as an input and that determine whether or not the target person is a registered user, and the output unit outputs an authentication result of the target person in response to not being in the specific state, and outputs information differing from the authentication result in response to being in the specific state.

### (Supplementary Note 3)

An information processing system according to Supplementary Note 3 is the information processing system according to Supplementary Note 2, wherein the output unit outputs information requesting the target person to perform a predetermined operation.

### (Supplementary Note 4)

An information processing system according to Supplementary Note 4 is the information processing system according to any one of Supplementary Notes 1 to 3, wherein the second integrated score is a value calculated based on based on a false acceptance rate.

### (Supplementary Note 5)

An information processing system according to Supplementary Note 5 is the information processing system according to any one of Supplementary Notes 1 to 4, further including a third integrated score calculation unit that calculates a third integrated score by integrating the first score and the second score such that a weight of the first score is larger than that in a case of calculation of the first integrated score, wherein the score determination unit determines that it is in the specific state, in response to one of the second integrated score and the third integrated score exceeding the predetermined threshold.

### (Supplementary Note 6)

An information processing system according to Supplementary Note 6 is the information processing system according to any one of Supplementary Notes 1 to 5, wherein the second inference model includes a plurality of models having different characteristics from each other, the second integrated score calculation unit calculates the second integrated score for each of the plurality of models, the score determination unit determines that it is in the specific state, in response to one of a plurality of second integrated scores exceeding the predetermined threshold.

### (Supplementary Note 7)

An information processing method according to Supplementary Note 7 is an information processing method that is executed by at least one computer, the information processing method including: acquiring a first score based on an output of a first inference model and a second score based on an output of a second inference model differing in characteristics from the first inference model; calculating a first integrated score by integrating the first score and the second score; calculating a second integrated score by integrating the first score and the second score such that a weight of the second score is larger than that in a case of calculation of the first integrated score; determining whether or not each of the first integrated score and the second integrated score exceeds a predetermined threshold, and determining whether or not it is in a specific state in which only the second integrated score exceeds the predetermined threshold; and outputting an inference result based on whether or not the first integrated score exceeds the predetermined threshold in response to not being in the specific state, and outputting information differing from the inference result in response to being in the specific state.

### (Supplementary Note 8)

A recording medium according to Supplementary Note 8 is a recording medium on which a computer program that allows at least one computer to execute an information processing method is recorded, the information processing method including: acquiring a first score based on an output of a first inference model and a second score based on an output of a second inference model differing in characteristics from the first inference model; calculating a first integrated score by integrating the first score and the second score; calculating a second integrated score by integrating the first score and the second score such that a weight of the second score is larger than that in a case of calculation of the first integrated score; determining whether or not each of the first integrated score and the second integrated score exceeds a predetermined threshold, and determining whether or not it is in a specific state in which only the second integrated score exceeds the predetermined threshold; and outputting an inference result based on whether or not the first integrated score exceeds the predetermined threshold in response to not being in the specific state, and outputting information differing from the inference result in response to being in the specific state.

### (Supplementary Note 9)

A computer program according to Supplementary Note 9 is a computer program that allows at least one computer to execute an information processing method, the information processing method including: acquiring a first score based on an output of a first inference model and a second score based on an output of a second inference model differing in characteristics from the first inference model; calculating a first integrated score by integrating the first score and the second score; calculating a second integrated score by integrating the first score and the second score such that a weight of the second score is larger than that in a case of calculation of the first integrated score; determining whether or not each of the first integrated score and the second integrated score exceeds a predetermined threshold, and determining whether or not it is in a specific state in which only the second integrated score exceeds the predetermined threshold; and outputting an inference result based on whether or not the first integrated score exceeds the predetermined threshold in response to not being in the specific state, and outputting information differing from the inference result in response to being in the specific state.

### (Supplementary Note 10)

An information processing apparatus according to Supplementary Note 10 is an information processing apparatus including: a score acquisition unit that acquires a first score based on an output of a first inference model and a second score based on an output of a second inference model differing in characteristics from the first inference model; a first integrated score calculation unit that calculates a first integrated score by integrating the first score and the second score; a second integrated score calculation unit that calculates a second integrated score by integrating the first score and the second score such that a weight of the second score is larger than that in a case of calculation of the first integrated score; a score determination unit that determines whether or not each of the first integrated score and the second integrated score exceeds a predetermined threshold, and that determines whether or not it is in a specific state in which only the second integrated score exceeds the predetermined threshold; and an output unit that outputs an inference result based on whether or not the first integrated score exceeds the predetermined threshold in response to not being in the specific state, and that outputs information differing from the inference result in response to being in the specific state.

The present disclosure is allowed to be changed, if desired, without departing from the essence or spirit of this disclosure which can be read from the claims and the entire specification. An information processing system, an information processing method, and a recording medium with such changes are also intended to be within the technical scope of the present disclosure.

### DESCRIPTION OF REFERENCE CODES

10 Information processing system
11 Processor
110 Scored acquisition unit
120 First integrated score calculation unit
130 Second integrated score calculation unit
140 Score determination unit
150 Output unit
160 Third integrated score calculation unit

What is claimed is:

1. An information processing system comprising:
at least one memory that is configured to store instructions; and
at least one processor that is configured to execute the instructions to:
acquire a first score based on an output of a first inference model and a second score based on an output of a second inference model differing in characteristics from the first inference model;
calculate a first integrated score by integrating the first score and the second score;
calculate a second integrated score by integrating the first score and the second score such that a weight of the second score is larger than that in a case of calculation of the first integrated score;
determine whether or not each of the first integrated score and the second integrated score exceeds a predetermined threshold, and determine whether or not it is in a specific state in which only the second integrated score exceeds the predetermined threshold; and
output an inference result based on whether or not the first integrated score exceeds the predetermined threshold in response to not being in the specific state, and output information differing from the inference result in response to being in the specific state.

2. The information processing system according to claim 1, wherein
the first inference model and the second inference model are authentication models that use information about a target person as an input and that determine whether or not the target person is a registered user, and
the at least one processor that is configured to execute the instructions to output an authentication result of the target person in response to not being in the specific state, and outputs information differing from the authentication result in response to being in the specific state.

3. The information processing system according to claim 2, wherein the at least one processor that is configured to execute the instructions to output the information requesting the target person to perform a predetermined operation.

4. The information processing system according to claim 2, wherein the second integrated score is a value calculated based on based on a false acceptance rate.

5. The information processing system according to claim 1, wherein the at least one processor that is configured to execute the instructions to:
calculate a third integrated score by integrating the first score and the second score such that a weight of the first score is larger than that in a case of calculation of the first integrated score; and
determine that it is in the specific state, in response to one of the second integrated score and the third integrated score exceeding the predetermined threshold.

6. The information processing system according to claim 1, wherein
the second inference model includes a plurality of models having different characteristics from each other,
the at least one processor that is configured to execute the instructions to calculate the second integrated score for each of the plurality of models,
the at least one processor that is configured to execute the instructions to determine that it is in the specific state, in response to one of a plurality of second integrated scores exceeding the predetermined threshold.

7. An information processing method that is executed by at least one computer, the information processing method comprising:
acquiring a first score based on an output of a first inference model and a second score based on an output of a second inference model differing in characteristics from the first inference model;
calculating a first integrated score by integrating the first score and the second score;
calculating a second integrated score by integrating the first score and the second score such that a weight of the second score is larger than that in a case of calculation of the first integrated score;
determining whether or not each of the first integrated score and the second integrated score exceeds a predetermined threshold, and determining whether or not it is in a specific state in which only the second integrated score exceeds the predetermined threshold; and
outputting an inference result based on whether or not the first integrated score exceeds the predetermined threshold in response to not being in the specific state, and outputting information differing from the inference result in response to being in the specific state.

8. A non-transitory recording medium on which a computer program that allows at least one computer to execute an information processing method is recorded, the information processing method including:
acquiring a first score based on an output of a first inference model and a second score based on an output of a second inference model differing in characteristics from the first inference model;
calculating a first integrated score by integrating the first score and the second score;
calculating a second integrated score by integrating the first score and the second score such that a weight of the second score is larger than that in a case of calculation of the first integrated score;
determining whether or not each of the first integrated score and the second integrated score exceeds a predetermined threshold, and determining whether or not it is in a specific state in which only the second integrated score exceeds the predetermined threshold; and
outputting an inference result based on whether or not the first integrated score exceeds the predetermined threshold in response to not being in the specific state, and outputting information differing from the inference result in response to being in the specific state.
